(19) United States
(12) Patent Application Publication
(10) Pub. No.: US 2002/0151647 A1
(43) Pub. Date: Oct. 17, 2002

(54) Polymer blends with controlled morphologies

(76) Inventors: Michael K. Laughner, Lake Jackson, TX (US); Jeffery E. Brann, Versoix (CH)

Correspondence Address: DUPONT DOW ELASTOMERS, LLC, LEGAL DEPARTMENT -- PATENTS, 1007 MARKET STREET, WILMINGTON, DE, 19898, US

(21) Appl. No.: 09/776,072

(22) Filed: Feb. 1, 2001

Related U.S. Application Data
(60) Provisional application No. 60/032,303, filed on Nov. 25, 1996.

(51) Int. Cl. C08L 51/08

(52) U.S. Cl. 525/63

(57) ABSTRACT

Thermoplastic polymer blend compositions that include a thermoplastic matrix resin phase that is substantially free of crosslinking and a dispersed, silane-grafted elastomer phase are prepared by a multi-step process that begins with melt mixing a thermoplastic resin and an elastomer that have similar viscosities at temperatures used for melt mixing. A catalyst that promotes silane crosslinking, branching or both is preferably, but not necessarily, added to the melt mixed phases either while they are in a melt state or after they have been recovered in a solid state. The melt mixed phases and the optional catalyst are then subjected to moisture, either before or after the melt mixed phases are converted to a shaped article, to effect branching and crosslinking within domains of the dispersed elastomer phase. The crosslinking and branching build elastomer molecular weight and stabilize dispersed domain shapes. The elastomer phase may contain a non-elastomeric polymer. A second, non-grafted elastomer phase may also be included in the thermoplastic polymer blend compositions.

This application claims the benefit of U.S. Provisional Application No. 60/032,303, filed Nov. 25, 1996.

### FIELD OF THE INVENTION

This invention relates generally to polymer blends having a polymer matrix component and a dispersed elastomer component and their preparation. This invention particularly relates to polymer blends wherein only the elastomer phase is branched, lightly crosslinked or both and to methods for preparing such polymer blends. This invention more particularly relates to such blends wherein branching, crosslinking or both occurs by way of a vinyl silane that is grafted onto the elastomer phase and to methods whereby timing of branching, crosslinking or both is used to provide enhanced rheological behavior and controlled morphology.

### BACKGROUND OF THE INVENTION

For many elastomeric applications, such as wire and cable insulation, weather-stripping, fibers, seals, gaskets, foams, footwear, flexible tubing, pipes, bellows and tapes, certain physical properties, such as tensile strength, compression set and increased end use temperature of articles manufactured from one or more polyolefins can be enhanced by introducing chemical linkages between molecular chains that constitute the polyolefin(s). As used herein, “crosslink(s)” refers to the presence of two or more chemical linkages between the same two molecular chains. Where only one chemical linkage exists between two molecular chains, that is referred to as a “branch point” or “branching”. Crosslinks and branch points can be introduced between different molecular chains by any of a number of mechanisms. One mechanism involves grafting a chemically reactive compound to individual molecular chains or polymer backbones that constitute a bulk polymer in such a manner that the grafted compound on one chain may subsequently react with a similar grafted compound on another chain to form the crosslink, branch point or both. Silane crosslinking exemplifies this mechanism.

A number of applications require high modulus. Illustrative applications that do so include automobile body parts such as bumper fascia, body side moldings, exterior trim, interior trim, air dams, air ducts, wheel covers and instrument panels, and non-automotive applications such as trash cans, storage containers, lawn furniture, lawn mowers and other garden appliance parts, recreational vehicle parts, golf cart parts, utility cart parts and water craft parts,. Industries associated with these applications are looking for easier flowing resins having high impact properties. In order to develop easier flowing blends, a low molecular weight, easy-flowing (relative to higher molecular weight analogues) thermoplastic matrix resin is used in conjunction with a low molecular weight elastomer having low elasticity and a low glass transition temperature (Tg) to facilitate dispersion of the elastomer phase into small particles within the easy-flowing polymer matrix resin. This approach is consistent with teachings suggesting that optimizing morphology in a multiphase polymer blend yields a preferred balance of physical properties. A typical means of optimizing morphology centers around selecting polymer blend components that have similar viscosities at melt mixing temperatures. A dramatic or substantial mismatch in viscosities at a melt mixing temperature usually leads to a failure of one polymer blend component to disperse properly in one or more other polymer blend components. Achieving high impact properties requires addition of a high molecular weight, highly elastic elastomer having a low Tg. As such, the goals of easy flowing resins and high impact properties are mutually incompatible via conventional routes.

L. A. Utracki and Z. H. Shi, in “Development of Polymer Blend Morphology During Compounding in a Twin-Screw Extruder, Part I: Droplet Dispersion and Coalescence—A Review”, Polymer Engineering and Science, December 1992, Vol. 32, No. 24, pages 1824-1833, note, at page 1824, that desirable performance, in terms of physical properties of polymer blends, “can be achieved by proper selection of blend components and an appropriate method of compounding and processing”. At page 24, they also note that properties of immiscible systems “to a great extent, are controlled by morphology, which in turn depends on the thermodynamic and the rheological properties as well as on deformation and thermal history”. From this, one might conclude that, with all other factors being equal, dispersion of one polymer blend component into another at melt blending conditions should occur more readily where the polymer blend components have similar viscosities at melt blending conditions than where the viscosities differ markedly at those conditions. As such, it would be desirable if there were available a means of blending an elastomer with a matrix polymer under melt blending conditions that favor dispersion of the elastomer and later building up elastomer molecular weight to stabilize the dispersed elastomer phase.

The compositions and processes of this invention provide an alternate route that meets the goals stated above. First, the compositions and processes promote dispersion of a grafted low molecular weight elastomer phase into small domains or particles within a polymer matrix resin to address the need for easier flowing resins. Second, the compositions and process of this invention address the need for desired high impact properties by curing the dispersed elastomer domains or particles to build molecular weight and elasticity.

### SUMMARY OF THE INVENTION

An aspect of the invention is a thermoplastic polymer blend composition comprising a thermoplastic matrix resin phase that is substantially free of crosslinking and a silane-grafted elastomer phase that is dispersed within the matrix resin phase as individual silane-grafted domains containing an elastomer that is branched, crosslinked or both via silane linkages to an extent sufficient to build elastomer molecular weight and render the domains less susceptible to deformation during processing of the composition than elastomer domains that are substantially free of branching and crosslinking, the thermoplastic matrix resin being at least one resin selected from the group consisting of a poly(alpha-olefin) homopolymer or copolymer, a polycarbonate, a polyester, a polyamide, a polyurethane, an acetal polymer, a styrene polymer or co-polymer, a polyphenylene ether polymer and poly(vinyl chloride), the elastomer phase being at least one polymer selected from the group consisting of substantially linear ethylene polymers, linear ethylene polymers, ultra low density polyethylenes, ethylene/alpha-olefin copolymers, ethylene/vinyl acetate copolymers, diene-modified ethylene/alpha-olefin copolymers, hydrogenated styrene/isoprene block polymers and hydrogenated styrene/butadiene block polymers.

A second aspect of the invention is a process for preparing a molded article from a thermoplastic polymer blend composition that comprises a thermoplastic matrix resin phase that is substantially free of crosslinking and a silane-grafted elastomer phase that is dispersed within the matrix resin phase as individual silane-grafted domains containing an elastomer that is capable of being branched, crosslinked or both, the process comprising: a) forming a blend of a thermoplastic matrix resin and a silane-grafted elastomer resin; b) converting the blend to a melt blend wherein the elastomer phase is predominantly present as individual domains that are dispersed within the thermoplastic matrix resin phase; and c) converting the melt blend into a shaped article wherein the elastomer phase is branched, lightly crosslinked or both.

Related aspects of the second aspect include addition of a catalyst that promotes crosslinking, branching or both via moisture-cured silane linkages and timing of when crosslinking occurs during the process. When branching, crosslinking or both occurs prior to the molding step, a composition having enhanced morphological and rheological properties is obtained.

### DESCRIPTION OF PREFERRED EMBODIMENTS

The thermoplastic polymer blend compositions desirably have a weight ratio of matrix resin to elastomer phase 50-99 parts by weight matrix resin to 50-1parts by weight elastomer phase, preferably 60-97 parts by weight matrix resin to 40-3 parts by weight elastomer phase, all parts being based on total composition weight, with total weight being 100 parts by weight. When the compositions contain a second, optional elastomer phase, the second elastomer phase is present in an amount of 1-30 parts by weight, preferably 3-20 parts by weight, based on total composition weight. The presence of the second elastomer phase necessarily leads to adjustment of the matrix resin amount and elastomer phase amount to bring the total composition weight to 100 parts by weight.

The elastomer phase of thermoplastic polymer blend compositions of the present invention is present as dispersed domains within the thermoplastic matrix resin phase. The elastomer phase preferably comprises a silane-grafted elastomer. Silane-grafted elastomer domains, interfacial regions between such domains and the matrix resin phase or both may further comprise a minor amount of at least one additional resin that is selected from the group consisting of a poly(alpha-olefin), a polycarbonate, a polyester, a polystyrene, and a styrene copolymer. The amount is preferably less than about 20 percent by weight (wt %), based upon domain weight. The amount is more preferably less than about 15 wt %. The additional resin is preferably at least partially silane-grafted.

The thermoplastic polymer blend compositions of the present invention optionally contain a second elastomer phase that is present as individual domains that are substantially free of silane grafting. The second elastomer phase comprises at least one elastomer selected from the group consisting of thermoplastic elastomers and core-shell elastomers.

“Ethylene polymers” means an ethylene/α-olefin copolymer or diene modified ethylene/α-olefin copolymer. Illustrative polymers include ethylene/propylene (EP) copolymers, ethylene/octene (EO) copolymers, ethylene/butylene (EB) copolymers and ethylene/propylene/diene modified (EPDM) interpolymers. More specific examples include ultra low linear density polyethylene (ULDPE) (e.g., Attane™ made by The Dow Chemical Company), homogeneously branched, linear ethylene/α-olefin copolymers (e.g. Tafmer™ by Mitsui PetroChemicals Company Limited and Exact™ by Exxon Chemical Company), homogeneously branched, substantially linear ethylene/α-olefin polymers (e.g. the Affinity™ polymers available from The Dow Chemical Company and Engage® polymers available from DuPont Dow Elastomers L.L.C.), and high pressure, free radical polymerized ethylene copolymers such as ethylene/vinyl acetate (EVA) polymers (e.g., the Elvax™ polymers manufactured by E. I. Du Pont de Nemours & Co.). The more preferred olefinic polymers are the homogeneously branched linear and substantially linear ethylene copolymers with a density (measured in accordance with ASTM D-792) from about 0.85 to about 0.92 g/cm³, especially from about 0.85 to about 0.90 g/cm³ and a melt index (measured in accordance with ASTM D-1238 (190° C./2.16) from about 0.01 to 500, preferably 0.05 to 150 g/10 minutes. The substantially linear ethylene copolymers and the various functionalized ethylene copolymers such as EVA (containing from about 0.5 to about 50 wt % units derived from vinyl acetate) are especially preferred, EVA polymers having a melt index (ASTM D-1238 (190° C./2.16) from about 0.01 to 500, preferably 0.05 to 150 g/10 minutes being very useful in the present invention. Hydrogenated styrene/butadiene block polymers and hydrogenated styrene/isoprene block polymers (e.g., the Kraton® G polymers available from Shell Chemical) have a melt index (ASTM D-1238 (230°C./2.16 kg weight) from about 0.01 to 500, preferably 0.05 to 150 g/10 minutes, and a density of 0.87 to 0.95, preferably 0.88 to 0.93 g/cm³.

“Substantially linear” means that a polymer has a backbone substituted with from 0.01 to 3 long-chain branches per 1000 carbons in the backbone.

“Long-chain branching” or “LCB” means a chain length of at least 6 carbon atoms. Above this length, carbon-13 nuclear magnetic resonance (C-13 NMR) spectroscopy cannot distinguish or determine an actual number of carbon atoms in the chain. In some instances, a chain length can be as long as the polymer backbone to which it is attached. For ethylene ∝-olefin copolymers, the long chain branch is longer than the short chain branch that results from the incorporation of the ∝-olefin(s) into the polymer backbone.

“Interpolymer” refers to a polymer having polymerized therein at least two monomers. It includes, for example, copolymers, terpolymers and tetrapolymers. It particularly includes a polymer prepared by polymerizing ethylene with at least one comonomer, typically an ∝-olefin of 3 to 20 carbon atoms (C₃-C₂₀). Illustrative α-olefins include propylene, 1-butene, 1-hexene, 4-methyl-1-pentene, 1-heptene, 1-octene and styrene. The α-olefin desirably has a C₃-C₁₀ α-olefin. Preferred copolymers include EP and ethylene-octene. Illustrative terpolymers include an ethylene/propylene/octene terpolymer as well as terpolymers of ethylene, a C₃-C₂₀ α-olefin and a diene such as dicyclopentadiene, 1,4-hexadiene, piperylene or 5-ethylidene-2-norbornene.

The substantially linear ethylene α-olefin interpolymers (“SLEPs” or “substantially linear ethylene polymers”) are characterized by narrow molecular weight distribution (MWD) and narrow short chain branching distribution (SCBD) and may be prepared as described in U.S. Pat. Nos. 5,272,236 and 5,278,272, relevant portions of both being incorporated herein by reference. The SLEPs exhibit outstanding physical properties by virtue of their narrow MWD and narrow SCBD coupled with long chain branching (LCB) The presence of LCB in these olefinic polymers allows for easier processing (faster mixing, faster processing rates) and allows for more efficient free radical crosslinking. U.S. Pat. No. 5,272,236 (column 5, line 67 through column 6, line 28) describes SLEP production via a continuous controlled polymerization process using at least one reactor, but allows for multiple reactors, at a polymerization temperature and pressure sufficient to produce a SLEP having desired properties. Polymerization preferably occurs via a solution polymerization process at a temperature of from 20° C. to 250° C., using constrained geometry catalyst technology.

Suitable constrained geometry catalysts are disclosed at column 6, line 29 through column 13, line 50 of U.S. Pat. No. 5,272,236. These catalysts may be described as comprising a metal coordination complex that comprises a metal of groups 3-10 or the Lanthanide series of the Periodic Table of the Elements and a delocalized pi-bonded moiety substituted with a constrain-inducing moiety. The complex has a constrained geometry about the metal atom such that the angle at the metal between the centroid of the delocalized, substituted pi-bonded moiety and the center of at least one remaining substituent is less than such angle in a similar complex containing a similar pi-bonded moiety lacking in such constrain-inducing substituent. If such complexes comprise more than one delocalized, substituted pi-bonded moiety, only one such moiety for each metal atom of the complex is a cyclic, delocalized, substituted pi-bonded moiety. The catalyst further comprises an activating co-catalyst such as tris(pentafluorophenyl) borane. Specific catalyst complexes are discussed in U.S. Pat. No. 5,272,236 at column 6, line 57 through column 8, line 58 and in U.S. Pat. No. 5,278,272 at column 7, line 48 through column 9, line 37. The teachings regarding the catalyst complexes in general and these specific complexes are incorporated by reference.

A SLEP is characterized by a narrow MWD and, if an interpolymer, by a narrow comonomer distribution. A SLEP is also characterized by a low residuals content, specifically in terms of catalyst residue, unreacted comonomers and low molecular weight oligomers generated during polymerization. A SLEP is further characterized by a controlled molecular architecture that provides good processability even though the MWD is narrow relative to conventional olefin polymers.

A preferred SLEP has a number of distinct characteristics, one of which is an ethylene content that is between 20 and 85 wt %, more preferably between 30 and 80 wt %, with the balance comprising one or more comonomers. The ethylene and comonomer contents are selected to attain a total monomer content of 100 wt %. SLEP comonomer content can be measured using carbon-13 nuclear magnetic resonance (C-13 NMR) Spectroscopy.

Additional distinct SLEP characteristics include I₂ and melt flow ratio (MFR or I₁₀/I₂). The interpolymers desirably have an I₂ (ASTM D-1238, condition 190° C./2.16 kilograms (kg) (formerly condition E), of 0.01-500 grams/10 minutes (g/10 min), more preferably from 0.05-150 g/10 min. The SLEP also has a I₁₀/I₂(ASTM D-1238) ≧5.63, preferably from 6.5-15, more preferably from 7 to 10. For a SLEP, the I₁₀/I₂ ratio serves as an indication of the degree of LCB such that a larger I₁₀/I₂ ratio equates to a higher degree of LCB in the polymer.

A further distinct characteristic of a SLEP is MWD (M_{w}/Mₙ or “polydispersity index”), as measured by gel permeation chromatography (GPC). M_{w}/Mₙ is defined by the equation:

M_{w}/Mₙ≦(I₁₀/I₂)−4.63

The MWD is desirably >0 and <5, especially from 1.5 to 3.5, and preferably from 1.7 to 3.

A homogeneously branched SLEP surprisingly has a MFR that is essentially independent of its MWD. This contrasts markedly with conventional linear homogeneously branched and linear heterogeneously branched ethylene copolymers where the MWD must be increased to increase the MFR.

A SLEP may be still further characterized as having a critical shear rate at onset of melt fracture (OSMF) of at least 50% greater than the critical shear rate at the OSMF of a linear olefin polymer that has a like I₂ and M_{w}/Mₙ.

SLEPs that meet the aforementioned criteria include, for example, ENGAGE® polyolefin elastomers and other polymers produced via constrained geometry catalysis by The Dow Chemical Company and DuPont Dow Elastomers L.L.C.

In addition to copolymers specified above, the elastomer component of the blends used in this invention can also include one or more terpolymers, e.g. an ethylene/propylene/diene monomer (EPDM), tetrapolymers, and the like. The diene monomer component of these elastomers include both conjugated and nonconjugated dienes. Examples of nonconjugated dienes include aliphatic dienes such as 1,4-pentadiene, 1,4-hexadiene, 1,5-hexadiene, 2-methyl-1,5-hexadiene, 1,6-heptadiene, 6-methyl-1,5-heptadiene, 1,7-octadiene, 7-methyl-1,6-octadiene, 1,13-tetradecadiene and 1,19-eicosadiene; cyclic dienes such as 1,4-cyclohexadiene, bicyclo[2.2.1]hept-2,5-diene, 5-ethylidene-2-norbornene, 5-methylene-2-norbornene, 5-vinyl-2-norbornene, bicyclo[2.2.1]oct-2,5-diene, 4-vinylcyclohex-1-ene, bicyclo[2.2.2]oct-2,6-diene, 1,7,7-trimethylbicyclo[2.2.]hept-2,5-diene, dicyclopentadiene, methyltetrahydroindene, 5-allylbicyclo[2.2.1]hept-2-ene, and 1,5-cyclooctadiene; aromatic dienes such as 1,4-diallylbenzene, 4-allyl-1H-indene; and trienes such as 2,3-diispropenylidiene-5-norbornene, 2-ethylidene-3-isopropylidene-5-norbornene, 2-propenyl-2,5-norbornadiene, 1,3,7-octatriene and 1,4,9-decatriene; with 5-ethylidene-2norbornene and 1,4-hexadiene being preferred nonconjugated dienes.

Examples of conjugated dienes include butadiene, isoprene, 2,3-dimethylbutadiene-1,3, 1,2-dimethylbutadiene-1,3, 1,4-dimethylybutadiene-1,3, 1-ethylbutadiene-1,3, 2-phenylbutadiene-1,3, hexadiene-1,3, 4-methylpentadiene-1,3, 1,3-pentadiene (CH3CH═CH—CH═CH2, commonly called piperylene) and 3-methyl-1,3-pentadiene; with 1,3-pentadiene being a preferred conjugated diene.

Exemplary terpolymers include ethylene/propylene/5-ethylidene-2-norbornene, ethylene/1-octene/5-ethylidene-2-norbornene, ethylene/propylene/1,3-pentadiene and ethylene/1-octene/1,3-pentadiene. Exemplary tetrapolymers include ethylene/propylene/mixed dienes, e.g. ethylene/propylene/5-ethylidene-2-norbornene/piperylene.

An A-B or A-B-A copolymer useful as a base for the silane-grafted elastomer phase can be either linear, branched, radial or teleblock, and can be either a di-block (“A-B”) copolymer, tri-block (“A-B-A”) copolymer, or radial teleblock copolymer with or without tapered sections, i.e. portions of the polymer where the monomers alternate or are in random order close to the point of transition between the A and B blocks.

The A portion is frequently prepared by polymerizing one or more vinyl aromatic hydrocarbon monomers such as the various styrenic monomers and substituted varieties thereof; has weight average molecular weight of about 4,000 to about 115,000; and has properties characteristic of thermoplastic substances in that it has the stability necessary for processing at elevated temperatures and yet possesses good strength below the temperature at which it softens. The B portion of the copolymer typically results from polymerizing substituted or unsubstituted C₃-C₁₀ dienes, particularly conjugated dienes such as butadiene or isoprene; has a weight average molecular weight of from about 20,000 to about 450,000; and is characterized by elastomeric properties that allow it to absorb and dissipate an applied stress.

To reduce oxidative and thermal instability, the A-B or A-B-A copolymers used herein can also desirably be hydrogenated to reduce the degree of unsaturation on the polymer chain and on the pendant aromatic rings.

The most preferred vinyl aromatic A-B or A-B-A copolymers are vinyl aromatic/conjugated diene block copolymers formed from styrene and butadiene or styrene and isoprene. When the styrene/butadiene copolymers are hydrogenated, they are frequently represented as styrene/(ethylene/butylene)copolymer in the diblock form, or as styrene/(ethylene/butylene)/styrene copolymer in the triblock form. When the styrene/isoprene copolymers are hydrogenated, they are frequently represented as styrene/(ethylene/propylene) copolymer in the diblock form, or as styrene/(ethylene/propylene)/styrene copolymer in the triblock form. Vinyl atomatic/diene A-B or A-B-A copolymers such as are described above are discussed in greater detail in Holden, U.S. Pat. No. 3,265,766, Haefele, U.S. Pat. No. 3,333,024, Wald, U.S. Pat. No. 3,595,942 and Witsiepe, U.S. Pat. No. 3,651,014, each of which is incorporated herein, and many are available commercially as the various Kraton™ elastomers from Shell Chemical Company.

Any silane, or a mixture of such silanes, that will effectively graft to the components of the thermoplastic polymer blend composition, especially the elastomer phase, can be used in the practice of this invention. Suitable silanes for the silane crosslinking process include those of the general formula:

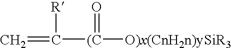

in which R′ is a hydrogen atom or methyl group; x and y are 0 or 1 with the proviso that when x is 1, y is 1; n is an integer from 1 to 12 inclusive, preferably 1 to 4, and each R independently is a hydrolysable organic group such as an alkoxy group having from 1to 12 carbon atoms (e.g. methoxy, ethoxy, butoxy), aryloxy group (e.g. phenoxy), aralkoxy group (e.g. benzyloxy), aliphatic acyloxy group having from 1 to 12 carbon atoms (e.g. formyloxy, acetyloxy, propanoyloxy), amino or substituted amino groups (alkylamine, arylamino), or a lower alkyl group having 1 to 6 carbon atoms inclusive, with the proviso that not more than two of the three R groups is an alkyl (e.g., vinyl dimethyl methoxy silane). Silanes useful in curing silicones which have ketoximino hydrolysable groups, such as vinyl tris(methylethylketoamino) silane, are also suitable. Useful silanes include unsaturated silanes that comprise an ethylenically unsaturated hydrocarboxyl group, such as a vinyl, ally, isopropyl, butyl, cyclohexenyl or gamma-(meth)acryloxy allyl group, and a hydrolysable group, such as, for example, a hydrocarbyloxy, hydrocarbonyloxy, or hydrocarbylamino group. Examples of hydrolysable groups include methoxy, ethoxy, formyloxy, acetoxy, proprionyloxy, and alkyl or arylamino group. Preferred silanes are the unsaturated alkoxy silanes which can be grafted onto the polymer. These silanes and their method of preparation are more fully described in U.S. Pat. No. 5,266,627 to Meverden, et al. Vinyl trimethoxy silane, vinyl triethoxy silane, gamma-(meth)acryloxy propyl trimethoxy silane and mixtures of these silanes are the preferred silanes for use in establishing crosslinks, branch points or both.

The amount of silane used in the practice of this invention can vary widely depending upon the nature of the elastomer phase components, the silane, the processing conditions, the grafting efficiency, the ultimate application, and similar factors, but typically at least 0.1, preferably at least 0.3, more preferably at least 0.4, parts per hundred elastomer resin (phr) is used. Considerations of convenience and economy are usually the two principal limitations on the maximum amount of silane used in the practice of this invention, and typically the maximum amount of silane does not exceed 3.5, preferably it does not exceed 2.5, more preferably it does not exceed 2.0, phr. As used in parts per hundred resin or phr, “resin” means the elastomer plus any other polymer(s) included with the elastomer during grafting. An amount of less than 0.1 wt % is undesirable because it does not result in enough branching, crosslinking or both to give enhanced morphological and rheological properties. An amount in excess of 3.5 wt % is undesirable because the elastomeric domains or phase becomes crosslinked to a level that is too high, thereby resulting in a loss of impact properties. An indication of level of crosslinking may be determined from gel content of the elastomer.

The silane is grafted to the resin (elastomer plus any other polymer(s) included with the elastomer during grafting), by any conventional method, typically in the presence of a free radical initiator e.g. peroxides and azo compounds, or by ionizing radiation, etc. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and tert-butyl peracetate. A suitable azo compound is azobisisobutyl nitrite. The amount of initiator can vary, but it is typically present in an amount of at least 0.04, preferably at least 0.06, phr. Typically the initiator does not exceed 0.15, preferably it does not exceed about 0.10 phr. The ratio of silane to initiator can also vary widely, but a typical silane:initiator ratio is between 10:1 and 30:1, preferably between 18:1 and 24:1.

While any conventional method can be used to graft the silane to the resin (elastomer plus any other polymer(s) included with the elastomer during grafting), one preferred method is blending the two with the initiator in the first stage of a reactor extruder, such as a single screw or a twin screw extruder, preferably one with a length/diameter (L/D) ratio of 25:1 or greater. The grafting conditions can vary, but the melt temperatures are typically between 160° C. and 280° C., preferably between 190° C. and 250° C., depending upon the residence time and the half life of the initiator.

Cure is accelerated with a cure or crosslinking or branching catalyst, and any catalyst that will provide this function can be used in this invention. These catalysts generally include organic bases, carboxylic acids and organometallic compounds including organic titanates and complexes or carboxylates of lead, cobalt, iron, nickel, zinc and tin. Illustrative catalysts include dibutyl tin dilaurate, dioctyl tin maleate, dibutyl tin diacetate, dibutyl tin dioctoate, stannous acetate, stannous octoate, lead naphthenate, zinc caprylate and cobalt naphthenate. Tin carboxylate, especially dibutyl tin dilaurate and dioctyl tin maleate, and titanium compounds, especially titanium 2-ethylhexoxide, are particularly effective for this invention. The catalyst (or mixture of catalysts) is present in a catalytic amount, typically between about 0.005 and about 0.3 phr, based on weight of elastomer. The crosslinks, branch points or both that result from the cure process can form between two elastomer molecules, two crystalline polyolefin polymer molecules, and/or an elastomer molecule and a crystalline polyolefin polymer molecule.

Preparation of polypropylene also involves the use of Ziegler catalysts, which allows the stereoregular polymerization of propylene to form isotactic polypropylene. The catalyst used is typically a titanium trichloride in combination with aluminum diethylmonochloride, as further described in Cecchin, U.S. Pat. No. 4,177,160.The various types of polymerization processes used for the production of polypropylene include the slurry process, which is run at about 50-90° C. and 0.5-1.5 MPa (5-15 atm), and the gas-phase and liquid-monomer processes, in which extra care must be given to the removal of amorphous polymer. Ethylene may be added to the reaction to form a polypropylene with ethylene blocks. Polypropylene resins may also be prepared by using any of a variety of metallocene, single site and constrained geometry catalysts together with their associated processes.

A polyamide is any of a variety of amine-functionalized polymers that may be used in preparation of a block terpolymer. When a polyamide is used as the matrix polymer, it is possible, and sometimes preferred, to use a different polyamide from that which was used to prepare the block terpolymer. For example, the polyamide used to prepare the block terpolymer may be a nylon 6, whereas the polyamide used as the matrix polymer may be a nylon-66, -11, -12, or -612, or have an average number of amine groups greater than about 2.0, or in the range of about 2.05 to about 3.5, or both.

Polycarbonates can be a bishaloformate of a glycol or dihhydroxy benzene, or a carbonate ester such as diphenyl carbonate or a substituted derivative thereof. These components are often reacted by means of the phase boundary process in which the dihydroxy compound is dissolved and deprotonated in an aqueous alkaline solution to form bisphenolate and the carbonate precursor is dissolved in an organic solvent.

Examples of some dihydroxy compounds suitable for the preparation of polycarbonate include variously bridged, substituted or unsubstituted aromatic dihydroxy compounds (or mixtures thereof represented by the formula:

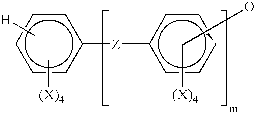

wherein:

(I) Z is (A) a divalent radical, of which all or different portions can be (I) linear, branched, cyclic or bicyclic, (ii) aliphatic or aromatic, and/or (iii) saturated or unsaturated, said divalent radical being composed of 1-35 carbon atoms together with up to five oxygen, nitrogen, sulfur, phosphorous and/or halogen (such as fluorine, chlorine and/or bromine) atoms; or (B) S, S₂, SO, SO₂, O or CO; or C a single bond;

(II) each X is independently hydrogen, a halogen (such as fluorine, chlorine and/or bromine), a C₁-C₁₂, preferably C₁-C₈, linear or cyclic alkyl, aryl, alkaryl, aralkyl, alkoxy or aryloxy radical, such as methyl, ethylene, isopropyl, cyclopentyl, cyclohexyl, methoxy, ethoxy, benzyl, tolyl, xylyl, phenoxy and/or xylynoxy; or a nitro or nitrile radical; and

(III) m is 0 or 1.

For example, the bridging radical represented by Z in the above formula can be a C₂-C₃₀ alkyl, cycloalkyl, alkylidene or cycloalkyidene radical, or two or more thereof connected by an aromatic or ether linkage, or can be a carbon atom to which is bonded one or more groups such as CH₃, C₂H₅, C₃H₇, n-C₃H₇, i-C₃H₇, cyclohexyl, bicyclo[2.2.1]heptyl, benzyl, CF₂, CF₃, CCl₃, CF₂Cl , CN(CH₂)₂COOCH₃, or PO(OCH₃)₂.

Representative examples of dihydroxy compounds of particular interest are the bis(hydroxyphenyl) alkanes, the bis(hydroxyphenyl)cycloalkanes, the dihdroxydiphenyls and the bis(hydroxyphenyl)sulfones, and in particular are 2,2-bis(4-hydroxyphenyl)propane (“Bisphenol-A” or “Bis-A”);2,3-bis(3,5-dihalo-4-hydroxyphenyl)propane (“Tetrahalo Bisphenol-A”) where the halogen can be fluorine, chlorine, bromine or iodine, for example, 2,2-bis(3,5-dibromo-4-hydroxyphenyl)propane (“Tetrabromo Bisphenol-A”) or “TBBA”); 2,2-bis(3,5-dialkyl-4-hydroxyphenyl)propane (“Tetraalkyl Bisphenol-A”) where the alkyl can be methyl or ethyl, for example 2,3-bis(3,5-dimethyl-4-hydroxyphenyl)propane (“Tetramethyl Bisphenol-A”); 1,1-bis*4-hydroxyphenyl)-1-phenyl ethane (“Bisphenol-AP” or “Bis-AP”); bishydroxy phenyl fluorine; and 1,1-bis(4-hydroxyphenyl) cyclohexane.

Polyester resins suitable for use as a matrix resin and methods of preparing polyester resins from various starting materials are described in U.S. Pat. No. 5,262,476 at column 6, line 65 through column 8, line 63. The resins may be made by self-esterification of hydroxycarboxylic acids, or direct esterification, which involves reaction of a diol with a dicarboxylic acid with an —[—AABB—]—polyester resulting via elimination of water. Temperatures applied typically exceed reactant melting points and often approach the diol's boiling point. Such temperatures usually range from about 150 to about 280° C. Direct esterification typically employs an excess of the diol and, after all of the acid has reacted with the diol, remaining diol is removed by distillation with applied heat and reduced pressure. In an alternate, but similar procedure, ester-forming derivatives of a dicarboxylic acid can be heated with a diol to obtain polyesters via an ester interchange reaction. Polyesters can also be produced by a ring-opening reaction of cyclic esters or lactones using an organic tertiary base, an alkali or alkaline earth metal, or a hydride or alkoxide of such a metal as an initiator. In addition to polyesters formed from a single diol and a single diacid, polyesters can be random, patterned or block copolyesters and can be prepared from combinations of two or more different diols, two or more different diacids or with other divalent heteroatomic groups.

Illustrative aromatic polyesters include polyethylene terephthalate and polybutylene terephthalate. Other teachings regarding polyesters may be found in U.S. Pat. No. 2,465,319, U.S. Pat. No. 3,047,539 and U.S. Pat. No. 3,756,986, the relevant portions thereof being incorporated herein by reference.

U.S. Pat. No. 5,262,476 provides teachings regarding suitable polyphenylene ethers (also known as polyphenylene oxides) at column 8, line 64 through column 10, line 31. Other teachings may be found in U.S. Pat. No. 4,866,130, the relevant teachings of which are incorporated herein by reference. These polymers typically comprise a plurality of structural units described generally by a formula

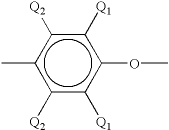

Independently in each of said units, each Q¹ is independently hydrogen, halogen, primary or secondary C₁-C₈ lower alkyl, phenyl, haloalkyl, aminoalkyl, hydrocarbonoxy, or halohydrocarbonoxy wherein at least two carbon atoms separate the halogen and oxygen atoms; and each Q² is independently hydrogen, halogen, primary or secondary C₁-C₈ lower alkys, phenyl, haloalkyl, hydrocarbonoxy or halohydrocarbonoxy as defined for Q¹.

Polyphenylene ethers are typically prepared by oxidative coupling of at least one corresponding monohydroxy-aromatic compound. One such compound is 2,6-xylenol.

The polyphenylene ethers may be homopolymers, copolymers and mixtures of both. An illustrative homopolymer includes 2,6-dimethyl-1,4-phenylene ether units. A typical random copolymer might include such units in combination with 2,3,6-trimethyl-1,4-phenylene ether units.

A polystyrene or vinyl aromatic polymer includes polymers prepared by bulk, suspension or emulsion polymerization that contain at least 25 wt % structural units derived from a monomer described generally by the formula

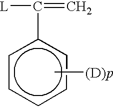

wherein L is hydrogen, C₁-C₈ lower alkyl or halogen, D is vinyl, halogen or lower alkyl, and p is from 0-5. These resins include homopolymers of styrene, chlorostyrene and vinyltoluene; random copolymers of styrene with one or more monomers illustrated by acrylonitrile, an alkyl acrylate, butadiene, α-methylstyrene, ethylvinylbenzene, divinylbenzene, maleic anhydride and phenyl maleimide; an ethylene/propylene/diene polymer grafted with acrylonitrile, styrene or both; and rubber modified styrenes comprising blends and grafts, wherein the rubber is a polybutadiene or a rubbery copolymer of about 70-98 wt % styrene and about 2-30 wt % diene monomer.

A variety of suitable styrene copolymers and methods used in preparing them are described in U.S. Pat. No. 5,262,476 at column 11, line 15 through column 12, line 63. The copolymers are typically prepared from a vinyl aromatic compound and one or more copolymerizable, ethylenically unsaturated monomers. Useful comonomers are disclosed at column 11, lines 17-38. The copolymers may be random, alternate, block or graft copolymers, and two or more copolymers may be used if desired. Elastomeric-thermoplastic composites, such as acrylonitrile/butadiene/styrene (ABS) polymers may be prepared by grafting a styrene/acrylonitrile (SAN) copolymer onto a polybutadiene latex as described at column 12, lines 16-63.

Poly(vinyl chloride) or PVC may be prepared, for example, by mass or suspension polymerization. In suspension polymerization, liquid monomer is dispersed under pressure in an aqueous solution containing a protective colloid and a monomer-soluble free radical initiator, such as a diacetyl peroxide or an alkyl peroxyester. Polymerization ensues when the reaction mixture is heated to 50-75° C. Other vinyl monomers can also be copolymerized with vinyl chloride monomer.

A polyurethane is typically prepared from a formulation of a polyisocyanate or diisocyanate “A” component, and an active-hydrogen-containing “B” component such as a polyol, polythiol or a polyamine or a combination thereof. U.S. Pat. No. 5,262,476 describes preferred isocyanates such as methylene diphenyldiisocyanate (MDI), various polyisocyanates and polyols at column 26, lines 4-56. A discussion of active hydrogen compounds follows at column 26, line 57 through colunin 27, line 59, with “copolymer polyols” being discussed at column 27, lines 50-59.

Acetals or polyacetals are polymers that result from opening the bond and polymerizing the carbonyl group of an aldehyde.

Supplemental or optional impact modifiers include, for example, core-shell grafted copolymer elastomers. These core-shell elastomers suitably include those that are based on either a diene rubber, an alkyl acrylate rubber, or on mixtures thereof, and have an elastomeric core made by polymerizing a diene, preferably a conjugated diene, or by copolymerizing a diene with a mono-olefin or a polar vinyl compound, such as styrene, acrylonitrile, or an alkyl ester of an unsaturated carboxylic acid such as methyl methacrylate. The substrate latex is typically made up of about 40-85% diene, preferably a conjugated diene, and about 15-60% of mono-olefin or polar vinyl compound. The elastomeric core phase should have a glass transition temperature (“Tg”) of less than about 10° C., and preferably less than about −20C. A mixture of ethylenically unsaturated monomers is then graft polymerized to the substrate latex. A variety of monomers may be used for this grafting purpose, of which the following are exemplary: vinyl compounds such as vinyl toluene or vinyl chloride; vinyl aromatics such as styrene, alpha-methyl styrene or halogenated styrene; acrylonitrile, methacrylonitrile or alpha-halogenated acrylonitrile; a C₁-C₈ alkyl acrylate such as ethyl acrylate or hexyl acrylate; a C₁-C₈ alkyl methacrylate such as methyl methacrylate or hexyl methacrylate; glycidyl methacrylate; acrylic or methacrylic acid; or a mixture of two or more of such monomers. The preferred grafting monomers include one or more of styrene, acrylonitrile and methyl methacrylate. Core-shell elastomers also include those with a hard core and an elastomeric shell.

The grafting monomers may be added to a reaction mixture simultaneously or in sequence, and, when added in sequence, layers, shells or wart-like appendages can be built up around the substrate latex, or core. Methyl methacrylate/butadiene/styrene (“MBS”) rubber is about 60-80 parts by weight substrate latex (butadiene), about 10-20 parts by weight of each of the first and second monomer shells (methyl methacrylate and styrene). A preferred formulation for an MBS rubber is one having a core built up from about 71 parts of butadiene, about 3 parts of styrene, about 4 parts of methyl methacrylate and about 1 part of divinyl benzene; a second phase of about 11 parts of methyl methacrylate and about 0.1 part of 1,3-butylene glycol dimethacrylate, where the parts are by weight of the total composition. A diene-based, core-shell graft copolymer elastomer and methods for making same, as described above, are discussed in greater detail in Saito, U.S. Pat. No. 3,287,443, Curfman, U.S. Pat. No. 3,657,391 and Fromuth, U.S. Pat. No. 4,180,494, each of which is incorporated herein.

Additional core-shell elastomers include grafted copolymers based on an alkyl acrylate rubber that has a first phase forming an elastomeric core and a second phase forming a rigid thermoplastic phase about the elastomeric core. The elastomeric core is formed by emulsion or suspension polymerization of monomers that consist of at least about 50 weight percent (wt %) alkyl and/or aralkyl acrylates having up to fifteen carbon atoms, and, although longer chains may be used, the alkyls preferably contain two to six carbon atoms, most preferably butyl acrylate. The elastomeric core phase should have a Tg of less than about 10° C., and preferably less than about −20° C. About 0.1 to 5 weight percent of (I) a cross-linking monomer that has a plurality of addition polymerizable reactive groups all of which polymerize at substantially the same rate, groups some of which polymerize at substantially different rates than others, such as diallyl maleate, is typically polymerized as part of the elastomeric core.

The rigid thermoplastic phase of the acrylate rubber is formed on the surface of the elastomeric core using suspension or emulsion polymerization techniques. The monomers necessary to create this phase together with necessary initiators are added directly to the reaction mixture in which the elastomeric core is formed, and polymerization proceeds until the supply of monomers is substantially exhausted. Ethylenically unsaturated monomers such as glycidyl methacrylate, or an alkyl ester of an unsaturated carboxylic acid, for example a C₁-C₈ alkyl acrylate like methyl acrylate, hydroxy ethyl acrylate or hexyl acrylate, or a C₁-C₈ alkyl methacrylate such as methyl methacrylate or hexyl methacrylate, or mixtures of any of the foregoing, are some of the vinyl monomers which can be used for this purpose. Either thermal or reduction-oxidation (redox) initiator systems can be used. Because of the presence of the graft linking agents on the surface of the elastomeric core, a portion of the chains which make up the rigid thermoplastic phase are chemically bonded to the elastomeric core. It is preferred that there be at least about 20% bonding of the rigid thermoplastic phase to the elastomeric core.

A preferred acrylate rubber is made up of more than from about 45 to about 95 wt % of an elastomeric core and about from 60 to about 5 wt % of a C₁-C₈ alkyl methacrylate, preferably methyl methacrylate. Acrylate rubbers and methods for making same, as described above, are discussed in greater detail in Owens, U.S. Pat. No. 3,808,180 and Witman, U.S. Pat. No. 4,299,m928, each of which is incorporated herein. Various diene-based and acrylate-based core-shell grafted copolymers are available commercially from Rohm & Haas as the Acryloid™ or Paraloid™ elastomers.

Other supplemental impact modifiers or thermoplastic elastomers useful in the compositions of this invention are those based generally on a long-chain, hydrocarbon backbone (“olefinic elastomers”), which may be prepared predominantly from various mono- or dialkenyl monomers and may be grafted with one or more styrenic monomers. Representative examples of a few olefinic elastomers which illustrate the variation in the known substances which would suffice for such purpose are as follows: butyl rubber; chlorinated polyethylene rubber; chlorosulfonated polyethylene rubber; an olefin polymer or copolymer such as ethylene/propylene copolymer, ethylene/octene-1 copolymer, ethylene/butene-1 copolymer, ethylene/styrene copolymer or ethylene/propylene/diene copolymer, which may be grafted with one or more styrenic monomers; neoprene rubber; nitrile rubber; hydrogenated styrene/butadiene rubbers; nitrile rubbers; polyester and polyurethane elastomers; polybutadiene and polyisoprene.

Suitable reactive compatibilizers include olefinic epoxide-containing compounds that are discussed in U.S. Pat. No. 5,308,894 at column 8, line 26 through column 9, line 65. In general, these compounds are formed as a polymer from (i) at least one olefin monomer such as ethylene, propylene, isopropylene, butylene, isobutylene, or a mixture thereof; and (ii) at least one vinyl or olefin monomer that caries at least one epoxide group. Representative vinyl monomers include vinyl aromatic compounds such as styrene, substituted styrenes such as α-methyl styrene or vinyl toluene, and halogenated styrene. Other suitable vinyl monomers are described at column 8, line 60 through column 9, line 13. Olefinically unsaturated monomers include glycidyl esters of unsaturated carboxylic acids, such as glycidyl methacrylate, and others described at column 9, lines 19-31. A brief description of a suitable process for preparing the olefinic epoxide-containing compounds follows at column 9, lines 37-58.

A variety of additives may be advantageously used in the compositions of this invention for other purposes such as the following, any one or more of which may be used: antimicrobial agents such as organometallics, isothazolones, organosulfurs and mercaptans; antioxidants such as phenolics, secondary amines, phosphites and thioesters; antistatic agents such as quaternary ammonium compounds, amines, and ethoxylated, propoxylated or glycerol compounds; fillers and reinforcing agents such as glass, metal carbonates such as calcium carbonate, metal sulfates such as calcium sulfate, talc, clay or graphite fibers; hydrolytic stabilizers; lubricants such as fatty acids, fatty alcohols, esters, fatty amides, metallic stearates, paraffinic and microcrystalline waxes, silicones and orthophosphoric acid esters; mold release agents such as fine-particle or powdered solids, soaps, waxes, silicones, polyglycols and complex esters such as trimethylolpropane tristearate or pentaerythritol tetrastearate; pigments, dyes and colorants; plasticizers such as esters of dibasic acids (or their anhydrides) with monohydric alcohols such as o-phthalates, adipates and benzoates; heat stabilizers such as organotin mercaptides, an octyl ester of thioglycolic acid and a barium or cadmium carboxylate; ultraviolet light stabilizers used as a hindered amine, an o-hydroxy-phenylbenzotriazole, a 2-hydroxy,4-alkoxyenzophenone, a salicylate, a cynoacrylate, a nickel chelate and a benzylidene malonate and oxalanilide. A preferred hindered phenolic antioxidant is Irganox™ 1076 antioxidant, available from Ciba-Geigy Corp. Each of the above additives, if used, typically does not exceed 45 percent by weight of the total composition, and are advantageously from about 0.001 to 20 percent, preferably from about 0.01 to 15 percent and more preferably from about 0.1 to 10 percent, by weight of the total composition.

Polymer blends of the present invention may be fabricated into parts, sheets or other form using any one of a number of conventional procedures. These procedures include, for example, injection molding, blow molding and extrusion. The compositions can also be formed, spun or drawn into films, fibers, multi-layer laminates or extruded sheets, or can be compounded with one or more organic or inorganic substances, on any machine suitable for such purposes. Fabrication may be conducted either before or after moisture curing, but is preferably conducted after moisture curing for enhanced rheological properties related to ease of processing.

A preferred process for preparing a molded article from a thermoplastic polymer blend composition that comprises a thermoplastic matrix resin phase that is substantially free of crosslinking and a silane-grafted elastomer phase that is dispersed within the matrix resin phase as individual silane-grafted domains has three steps. In step a), a thermoplastic polymer matrix resin, such as polypropylene homopolymer or a propylene/alpha-olefin copolymer, is physically blended with a silane-grafted elastomer such as a silane-grafted SLEP. Preparation of a silane-grafted polymer may be accomplished as described above or as detailed in Examples 1-3 below. Physical blending desirably occurs by dry blending. The physically mixed polymers are then melt mixed in step b), preferably in a single screw or twin screw extruder that heats the polymers to a temperature suitable for melting the polymers. With preferred polymers like polypropylene and a silane-grafted SLEP, the temperature is 240° C. The extruder is operated at a rate sufficient to effect melt mixing of the polymers. The rate will depend upon the polymers of choice and the type and size of extruder. The 30 mm twin screw extruder used in Examples 1-3 operates at a rate of 247 rpm with the preferred polymers used in those examples. A tin catalyst, such as DBTDL, is preferably added to the melt mixed polymers before they exit the extruder and are passed through a chilled water bath, chopped into granules and collected for further processing in step c). Step c) involves converting the melt blend into a shaped article wherein the silane-grafted elastomer phase is branched, lightly crosslinked or both. Step c) is preferably a molding process selected from the group consisting of injection molding, blow molding, injection blow molding, extrusion blow molding, co-injection molding, co-extrusion molding, a combination of sheet or film extrusion followed by thermoforming, compression molding, and parison molding. If, for example, the process is injection molding, addition of the tin catalyst may be delayed until the mixed polymers are in a melted state within an injection molding apparatus. On a small scale, the tin catalyst is preferably added as a dispersion in mineral oil. On a larger scale, a skilled artisan can readily determine alternate means of addition such as use of a concentrate of catalyst in a polymer that is compatible with components of the polymer blend.

A number of variations of the above three step process are feasible and those described below are simply examples and are not to be construed as limiting the scope of the present invention. Skilled artisans will readily be able to discern additional variations without undue experimentation.

One variation incorporates an intermediate step b1) between steps b) and c). In step b1), the elastomer phase domains are exposed to an amount of water and for a period of time sufficient to promote branching, crosslinking or both within the domains. Crosslinking, branching or both preferably occurs to an extent sufficient to build elastomer molecular weight within the domains and render the domains less susceptible to deformation during step c) than elastomer domains that are substantially free of crosslinking.

A second variation adds a step d) after step c). In step d), the shaped article is exposed to an amount of water and for a period of time sufficient to promote branching, crosslinking or both within the elastomer phase domains. Crosslinking, branching or both occur to an extent sufficient to improve impact properties of the shaped article without converting the shaped article to a thermoset article.

The three step process and either or both of the first and second variations may be modified to accommodate a second elastomer phase that is present as individual domains that are substantially free of silane-grafting. The second elastomer phase comprises at least one elastomer selected from the group consisting of thermoplastic elastomers and core-shell elastomers. Addition of the elastomer(s) for the second phase preferably occurs during step a).

The three step process and any of the foregoing variations or modifications may be further modified by choice of when to add a catalyst that promotes crosslinking, branching or both of the silane-grafted elastomer domains. The catalyst may be added prior to step a), during step a), during step b), after step b) but prior to step c), or a combination thereof.

If desired, any or all of the three step process and the foregoing modifications and variations may be altered by adding an intermediate step between steps b) and c). Where the process has already been modified by adding step b1), the intermediate step preferably follows step b1). The intermediate step comprises recovering the melt blend as solid particles. The intermediate step may be followed by a second intermediate step wherein the catalyst that promotes crosslinking, branching or both of the elastomer domains is added to the solid particles prior to step c).

The three step process, with or without modification to add the second elastomer phase, may further comprise three sequential steps b1), b2) and b3) that are intermediate between steps b) and c). Step b1) comprises recovering the melt blend as solid particles. Step b2), which follows step b1), comprises converting the solid particles to a melt. Step b3), which follows step b2), comprises adding a catalyst that promotes crosslinking, branching or both of the elastomer domains to the solid particles.

The three step process, with or without modification to add the second elastomer phase, may further adding a minor amount of at least one resin selected from the group consisting of a poly(alpha-olefin), a polycarbonate, a polyester, a polystyrene, and a styrene copolymer in step a).

The following examples illustrate but do not, either explicitly or by implication, limit the present invention. Unless otherwise stated, all parts and percentages are by weight, on a total weight basis. Examples of the present invention are identified by Arabic numerals and comparative examples are represented by letters of the alphabet.

### EXAMPLES 1-3 AND COMPARATIVE EXAMPLE A

A SLEP or polyolefin elastomer is grafted with vinyl trimethoxy silane (VTMOS) using dicumyl peroxide (DCP) as a free radical initiator. Using a VTMOS:DCP weight ratio of 20:1, graft polymers having respective VTMOS contents of 0.4 wt % for Example 1, 0.8 wt % for Example 2 and 1.2 wt % for Example 3 are prepared. The SLEP is an experimental ethylene/octene-1 copolymer having a density of 0.858 grams per cubic centimeter (g/cm3), a melt index of 1 gram per 10 minutes (g/10 min) and being available from DuPont Dow Elastomers L.L.C. The VTMOS, and DCP are all commercially available from Aldrich Chemical. Comparative Example A is neat, ungrafted (no VTMOS or DCP) SLEP.

A solution of VTMOS and DCP is added to a container together with dry pellets of the SLEP. The container is sealed and the contents mixed for 20 to 40 minutes to allow uniform absorption onto and into the pellets. The contents of the container are then transferred to a ZSK 30 millimeter (mm), Werner Pfleiderer, co-rotating, twin screw extruder equipped with a high shear mixing screw. By operating at a temperature of 250 degrees centigrade (°C.) and a speed of 250 revolutions per minute (RPM), the extruder effectively melt mixes the container contents. The melt mixed container contents are then converted to graft polymer by free radical addition of the vinyl silane monomer. The melt mixed graft polymer is then cooled, strand cut into pellets and collected for further processing. This step is omitted for Comparative Example A, thereby ultimately giving Comparative Example A exposure to one less heat history or melt processing step than Examples 1-3.

For Examples 1-3, polymer blends are prepared by first mixing the graft polymer pellets with 0.3 milliliters (ml) per 1000 grams (g) of graft polymer of a solution of 25 wt % dibutyl tin dilaurate (DBTDL) (commercially available from Aldrich Chemical) and 75 wt % mineral oil, both percentages being based on total solution weight. Mixing occurs by adding the solution to the graft polymer pellets in a container, closing the container and then shaking the container and its contents to distribute the solution over the pellets. As there are no crosslinkable moieties in neat, ungrafted SLEP, this mixing step is omitted for Comparative Example A. For each of Examples 1-3 and Comparative Example A, the pellets are then promptly dry blended with pellets of an isotactic polypropylene homopolymer in a weight ratio of 75 parts by weight (pbw) of polypropylene to 25 pbw graft polymer, based upon combined weight of polypropylene and graft polymer. The polypropylene has a melt flow rate (MFR) at 230° C. and 2.16 kg of 35 and is commercially available from Himont under the trade designation Profax® PD-701. The polymer blends are then melt blended in an extruder like that used in grafting, but equipped with a different screw configuration. The configuration used in preparing melt blends has basic kneading blocks followed by gear mixer flights to produce a medium shear, high mixing configuration. The extruder operates at a temperature of 240° C. and a speed of 247 RPM. The melt blends are passed through a chilled water bath, chopped into granules and collected for injection molding.

In order to speed crosslinking of certain portions of the granules for Examples 1-3, 40 milliliters (mls) of water is added to each 2000 gram portion and sealed in a polyethylene bag. The portions are then placed in an oven operating at a set temperature of 50° C. for 24 hours. After the 24 hour period, the portions are removed from the bags, placed in an open pan and transferred to a forced air oven operating at a set temperature of 105° C. for four hours to yield granules suitable for injection molding. Comparative Example A, which contains no crosslinkable moieties, is not subjected to this step.

American Society for Testing and Materials (ASTM) samples are prepared by injection molding on a 70 ton (about 63,600 kilograms (kg)) Arburg molding machine. Molding temperatures for the barrel are set at 220° C. (feed), 210° C., 200° C. and 200° C. (barrel through nozzle) while the mold temperature is 40° C. Injection cycles are maintained at 1.8 seconds injection, 15 seconds holding and 20 seconds cooling. The injection and hold pressures are approximately 20 to 25 bars (2.0 to 2.5 megapascals (Mpa)) and are adjusted as needed to completely fill mold cavities. Such adjustments are readily made by skilled artisans.

ASTM standard procedures are used to evaluate molded samples. In addition, notched Izod values are obtained using an Izod impact tester and a low speed notcher equipped with a 10 mil (0.25 millimeter (mm)) wheel in accordance with ASTM D-256. Unnotched weldline Izod samples are cut from the middle of a double gated tensile bar and tested on the Izod impact tester. Transmission Electron Microscopic (TEM) evaluation of samples is performed using a magnification of 6000× or higher and ruthenium chloride (RuCl₄) stained samples. Test results are shown in Table I below. Izod impact values are measured in terms of foot-pounds per square inch (fpsi) or kilojoules per square meter (kjsm). Tensile strengths are measured in terms of pounds per square inch (psi) or Mpa.

TABLE I

| Example | | | | |
|---|---|---|---|---|
| Number/Physical | | | | Comparative |
| Property | Example 1 | Example 2 | Example 3 | Example A |
| Izod Impact @ 23° C. | 13.5/28.4 | 13.7/28.8 | 13.5/28.4 | 2.2/4.6 |
| (fpsi/kjsm) | | | | |
| Izod Impact @ 0° C. | 3.1/6.5 | 4.1/8.6 | 9.4/19.8 | 1.7/3.6 |
| (fpsi/kjsm) | | | | |
| Weldline Izod at | No Break | 20.0/42.0 | 19.7/41.4 | 4.8/10.1 |
| 23° C. (fpsi/kjsm) | | | | |
| Weldline Ultimate | 2679/18.5 | 2582/17.8 | 2634/18.2 | 2439/16.8 |
| Tensile (psi/Mpa) | | | | |
| Weldline | 63 | 57 | 51 | 9 |
| Percent Elongation | | | | |
| Sample Ultimate | 2695/18.6 | 2758/19.0 | 2980/20.5 | 2827/19.5 |
| Tensile (psi/Mpa) | | | | |
| Sample Percent | >1000 | >1000 | >1000 | 924 |
| Elongation | | | | |

The data in Table I demonstrate that blends of the present invention all possess a combination of desirable Izod impact values, tensile properties and elongation values. By way of contrast, Comparative Example A, a melt blended polymer that contains no silane grafting, has substantially lower Izod impact values and weldline elongation values. In addition, weldline ultimate tensile is lower as is the sample elongation value. As such, the data demonstrate that silane grafting of the elastomer yields property advantages relative to blends prepared wherein the elastomer phase has no silane grafting even where the latter blends are subjected to one less heat history than the former blends where silane grafting is present.

### EXAMPLES 4-10

Using a modified version of the procedure of Examples 1-3, seven crosslinkable polymers are prepared. Examples 7-10 are prepared with different grafted elastomers. Examples 4-6 are prepared with the same ethylene/octene-1 polymer (EO-1) as Examples 1-3. Examples 7 and 8 are prepared with Engage® 8190, a blend (designated as EO-2) of 93 wt % EO-1 and 7 wt % PP-2, the blend having an overall density of 0.859 g/cm³ and a melt index (190° C., 2.16 kg) of one g/10 min and being available from DuPont Dow Elastomers L.L.C. Engage® is a registered trademark of DuPont Dow Elastomers L.L.C. Example 9 is prepared with a blend of 90 wt % EO-1 and 10 wt % of a polycarbonate resin (PC-1), the polycarbonate resin having a melt flow rate of 80 g/10 min (ASTM D-1238, 300° C., 1.2 kg) and being available from The Dow Chemical Company as XU-73109.01. Example 10 is prepared with 90 wt % EO-1 and 10 wt % of an amorphous polyester resin (Kodak® PCTG) that is commercially available from Eastman Kodak. Prior to preparation of the graftable polymers, the PC-1 and PCTG were predried overnight at a temperature of 105° C. Table II below shows the amounts in grams of polymers, VTMOS and DCP. Table II also shows the melt index (MI) in g/10 min of each graftable polymer immediately after extrusion.

TABLE II

| Example Number/ | | | | | | | |
|---|---|---|---|---|---|---|---|
| Component & Melt | | | | | | | |
| Index | 4 | 5 | 6 | 7 | 8 | 9 | 10 |
| EO-1 | 2500 | 1500 | 1500 | | | 1350 | 1350 |
| EO-2 | | | | 1500 | 1500 | | |
| PC-1 | — | — | — | — | — | 150 | — |
| PCTG | — | — | — | — | — | — | 150 |
| VTMOS | 25 | 18 | 22.5 | 12 | 18 | 15 | 15 |
| DCP | 1.25 | 0.9 | 1.13 | 0.6 | 0.9 | 0.75 | 0.75 |
| MI (g/10 min) | 0.575 | 0.351 | 0.312 | 0.880 | 0.849 | 0.802 | 0.230 |

### EXAMPLES 11-25 AND COMPARATIVE EXAMPLES B AND C

With certain variations explained below, a series of sixteen (Examples 11-24 and Comparative Examples B and C) melt blends is prepared as in Examples 1-3 and, for Comparative Examples B and C, Comparative Example A. Examples 11-24 use the graftable polymers prepared in Examples 4-9. Comparative Examples B and C, like Comparative Example A, use EO-1, contain no silane grafting and are not mixed or prepared with DBTDL. In Examples 11-15, the melt blends are prepared without any DBTDL because DBTDL is added at the molding machine as described below. Examples 16-24 are prepared with 200 ppm DBDTL that is added as described in Examples 1-3 and further described below. Comparative Example B and Examples 11-20 are prepared with the same polypropylene homopolymer (PP-1) as in Examples 1-3. Comparative Example C and Examples 21-24 are prepared with a polypropylene homopolymer (PP-2) having a MFR of 12 g/10 min and being commercially available from Himont under the trade designation Profax® 6323. Irganox® 1010, a phenolic antioxidant (AO-1) commercially available from Ciba Geigy is added in the levels indicated in Table III. Formulations for Examples 11-24 are shown in Table III below wherein all amounts are in grams.

Example 25 uses a graftable polymer with a higher level of VTMOS grafting and is prepared by adding 0.3 cubic centimeter (cc) of a mixture of 25 wt % DBTDL in 75 wt % mineral oil, both percentages being based on mixture weight, to 538 grams of EO-2 that has been grafted with 1.8 wt % VTMOS using the procedure of Examples 1-3. The graft polymer and DBTDL/mineral oil mixture are shaken for one minute, blended with 1462 grams of PP-2, shaken for one additional minute and immediately extruded to form pellets suitable for injection molding.

In Examples 11-15, 200 ppm of DBTDL is added at the molding machine. Molded parts are collected and placed in sealed polyethylene bags that contain 40 g of water. Each bag is placed in an oven operating at a set temperature of 50° C. for 24 hours to promote crosslinking of the elastomer domains via moisture curing. The parts are then removed from the bag and air dried using a set temperature of 50° C. for eight hours. Air drying is followed by conditioning at room temperature and a humidity of 50% for 72 hours before testing. The 50° C. oven aging of molded parts can result in partial annealing of the parts. Annealing results, in turn, in increased crystallization of the polypropylene phase. The increased crystallization accounts, at least in part, for higher modulus and heat distortion properties than might otherwise be expected. Results for Examples 11-15 are summarized in Table IV below.

In Examples 16-20, 200 ppm of DBTDL is added during the melt blending process at the extruder. Extrudate pellets are collected and placed in sealed polyethylene bags that contain 40 g of water. Each bag is placed in an oven operating at a set temperature of 50° C. for 24 hours to promote crosslinking of the elastomer domains via moisture curing. The pellets are then removed from the bags and air dried for 16 hours at 100° prior to molding. Results for Examples 16-20 are summarized in Table V below.

Examples 21-25 employ the same procedure for adding DBTDL as Examples 16-20. Results for Examples 21-25 are summarized in Table VI below.

In Tables IV-VI, and VII-IX tensile and modulus values are expressed as psi/Mpa, and Dynatup Energy values are expressed as foot pounds (ft-p) or Joules (J). In addition “NB” means no break and “+” in the data portion represents the value at which testing stopped with no break occurring.

TABLE III

| Component/ | | | | | | | | | | |
|---|---|---|---|---|---|---|---|---|---|---|
| Example No. | PP-1 | PP-2 | EO-1 | Ex 4 | Ex 5 | Ex 6 | Ex 7 | Ex 8 | Ex 9 | AO-1 |
| B | 1500 | — | 500 | — | — | — | — | — | — | 4 |
| 11 | 3000 | — | | 1000 | — | — | — | — | — | 4 |
| 12 | 3000 | — | | — | 1000 | — | — | — | — | 6 |
| 13 | 3000 | — | | — | — | 1000 | — | — | — | 6 |
| 14 | 2925 | — | | — | — | — | 1075 | — | — | 6 |
| 15 | 2925 | — | | — | — | — | — | 1075 | — | 6 |
| 16 | 3000 | — | | 1000 | — | — | — | — | — | 4 |
| 17 | 3000 | — | | — | 1000 | — | — | — | — | 6 |
| 18 | 3000 | — | | — | — | 1000 | — | — | — | 6 |
| 19 | 2925 | — | | — | — | — | 1075 | — | — | 6 |
| 20 | 2925 | — | | — | — | — | — | 1075 | — | 6 |
| C | — | 1500 | 500 | — | — | — | — | — | — | 4 |
| 21 | — | 1500 | | 500 | — | — | — | — | — | 4 |
| 22 | — | 1462 | | — | — | — | 538 | — | — | 4 |
| 23 | — | 1462 | | — | — | — | — | 538 | — | 4 |
| 24 | — | 1500 | | — | — | — | — | — | 500 | 4 |

TABLE IV

| Example Number/Test | | | | | | |
|---|---|---|---|---|---|---|
| Result | B | 11 | 12 | 13 | 14 | 15 |
| Hardness Shore D @ 1 Sec | 65.3 | 66.5 | 66.2 | 66.2 | 65.9 | 65.9 |
| Tensile @ Break (psi/MPa) | 2350/ | 3244+/2 | 3171+/2 | 3319+/2 | 2756+/1 | 3289+/2 |
| | 16.2 | 2.4+ | 1.9+ | 2.9+ | 9.0+ | 2.7+ |
| Elongation (%) | 308.4 | >500 | >500 | >500 | >500 | >500 |
| Tensile @ Yield (psi/MPa) | 2982/ | 3011/ | 3024/ | 2989/ | 3020/ | 2972/ |
| | 20.6 | 20.8 | 20.8 | 20.6 | 17.6 | 20.5 |
| Tensile Modulus (psi/MPa) | 65305/ | 65853/4 | 61990/4 | 67307/4 | 65901/4 | 62897/4 |
| | 450.3 | 54.0 | 27.4 | 64.1 | 54.4 | 33.7 |
| Weldline Tensile @ Break | 2404/ | 1834/ | 2255/ | 2992/ | 2558/ | 2196/ |
| (psi/Mpa) | 16.6 | 12.6 | 15.5 | 20.6 | 17.6 | 15.1 |
| Weldline Elongation (%) | 7.15 | 19.52 | 18.30 | 445.25 | 9.91 | 16.27 |
| Weldline Tensile @ Yield | 2464/ | 2736/ | 2789/ | 2698/ | 2657/ | 2749/ |
| (psi/Mpa) | 17.0 | 18.9 | 19.2 | 18.6 | 18.3 | 19.0 |
| Weldline Unnotched Izod | 6.3/ | 8.5/ | 8.2/ | 8.5/ | 5.6/ | 7.6/ |
| (ft-lbs/in) (fpsi/kjsm) | 13.2 | 17.9 | 17.2 | 17.9 | 11.8 | 16.0 |
| 3-Point Flex Modulus | 107012/ | 108362/ | 111162/ | 110690/ | 110586/ | 110106/ |
| (psi/Mpa) | 737.8 | 747.1 | 766.4 | 763.2 | 762.5 | 759.2 |
| 3-Point Flex, 2% Secant | 93673/ | 93929/ | 95721/ | 93615/ | 93533/ | 94974/ |
| Modulus (psi/Mpa) | 645.9 | 647.6 | 660.0 | 645.5 | 644.9 | 654.8 |
| Dynatup (ft-p/J) Total | 31.16/ | 30.78/ | 32.63/ | 32.25/ | 31.18/ | 32.34/ |
| Energy @ 23° C. | 42.2 | 41.7 | 44.2 | 43.7 | 42.3 | 43.8 |
| Dynatup (ft-p/J) Total | 50.11/ | 39.59/ | 46.89/ | 48.84/ | 48.03/ | 48.46/ |
| Energy @ −30° C. | 67.9 | 53.7 | 63.6 | 66.2 | 65.1 | 65.7 |
| Izod Impact (fpsi/kjsm) @ | 6.24/ | 11.56/ | 10.85/ | 11.68/ | 3.07/ | 11.19/ |
| 23° C. | 13.1 | 24.3 | 22.8 | 24.5 | 6.5 | 23.5 |
| Izod Impact (fpsi/kjsm) @ | 1.33/ | 1.64/ | 1.91/ | 2.07/ | 1.68/ | 2.64/ |
| 0° C. | 2.8 | 3.4 | 4.0 | 4.4 | 3.5 | 5.5 |
| Heat Distortion @ 66 psi in | 62.7 | 66.4 | 64.2 | 63.8 | 64.2 | 64.1 |
| ° C. | | | | | | |
| 12 @ 230° C./2.16 kg load | 14.58 | 14.25 | 10.16 | 9.35 | 14.66 | 12.42 |

TABLE V

| Example No/Test Result | 16 | 17 | 18 | 19 | 20 |
|---|---|---|---|---|---|
| Hardness Shore D @ 1 Sec | 65.5 | 65.8 | 66.1 | 65.4 | 65.5 |
| Tensile @ Break (psi/MPa) | 3067+/ | 3213+/ | 3265+/ | 3200+/ | 3248+/ |
| | 21.1+ | 22.2+ | 22.5+ | 22.1+ | 22.4+ |
| Elongation (%) | >635 | >635 | >635 | >635 | >635 |
| Tensile @ Yield (psi/MPa) | 2704/ | 2688/ | 2684/ | 2709/ | 2721/ |
| | 18.6 | 18.5 | 18.5 | 18.7 | 18.8 |
| Tensile Modulus (psi/MPa) | 67479/ | 65735/ | 67445/ | 67435/ | 67179/ |
| | 465.3 | 453.2 | 465.0 | 465.0 | 463.2 |
| Weldline Tensile @ Break | 1982/ | 2106/ | 2141/ | 1978/ | 2098/ |
| (psi/MPa) | 13.7 | 14.5 | 14.8 | 13.6 | 14.5 |
| Weldline Elongation (%) | 35.26 | 31.98 | 34.60 | 21.98 | 26.86 |
| Weldline Tensile @ Yield (psi/MPa) | 2570/ | 2608/ | 2606/ | 2528/ | 2595/ |
| | 17.7 | 18.0 | 18.0 | 17.4 | 17.9 |
| Weldline Modulus (psi/Mpa) | 57887/ | 58910/ | 57637/ | 61121/ | 58663/ |
| | 399.1 | 406.2 | 397.4 | 421.4 | 404.5 |
| 3-Point Flex Modulus (psi/Mpa) | 104652/ | 94257/ | 92188/ | 91034/ | 91506/ |
| | 721.6 | 649.9 | 635.6 | 627.7 | 630.9 |
| 3-Point Flex, 2% Secant Modulus | 83488/ | 84186/ | 85236/ | 83578/ | 84746/ |
| (psi/Mpa) | 575.6 | 580.4 | 587.7 | 576.3 | 584.3 |
| Dynatup (ft-lbs) Total Energy @ | 39.13/ | 35.99/ | 41.87/ | 35.20/ | 38.54/ |
| 23° C. | 53.1 | 48.8 | 56.8 | 47.7 | 52.3 |
| Dynatup (ft-lbs) Total Energy @ - | 38.12/ | 39.66/ | 43.33/ | 42.63/ | 43.42/ |
| 30° C. | 51.7 | 53.8 | 58.7 | 57.8 | 58.9 |
| Izod Impact (fpsi/kjsm) @ 23° C. | 13.79/ | 13.34/ | 13.77/ | 14.55/ | 14.02/ |
| | 29.0 | 28.0 | 28.9 | 30.6 | 29.5 |
| Izod Impact (fpsi/kjsm) @ 0° C. | 2.57/ | 2.50/ | 3.26/ | 12.93/ | 12.30/ |
| | 5.4 | 5.3 | 6.9 | 27.2 | 25.8 |
| Izod Impact (fpsi/kjsm) @ −20° C. | — | — | — | 2.15/ | 2.11/ |
| | | | | 4.5 | 4.4 |
| Heat Distortion @ 66 psi in ° C. | 56.9 | 56.1 | 56.6 | 54.9 | 55.4 |
| 12 @ 230° C./2.16 kg load | 7.2 | 6.9 | 7.1 | 4.4 | 6.3 |
| Unnotched Weldline Izod | NB | NB | NB | 17.0/ | 16.8/ |
| (fpsi/kjsm) | | | | 35.7 | 35.3 |

TABLE VI

| Example Number/Test Result | C | 21 | 22 | 23 | 24 | 25 |
|---|---|---|---|---|---|---|
| Hardness Shore D @ 1 Sec | 64.9 | 65.6 | 65.2 | 65.9 | 65.3 | 65.6 |
| Tensile @ Break (psi/MPa) | 2197/ | 3370+/ | 3410+/ | 3409+/ | 3405+/ | 3649+/ |
| | 15.1 | 23.2+ | 23.5+ | 23.5+ | 23.5+ | 25.2+ |
| Elongation (%) | 342.7 | >635 | >635 | >635 | >550 | >550 |
| Tensile @ Yield (psi/MPa) | 3045/ | 2975/ | 2948/ | 2985/ | 2958/ | 2946/ |
| | 21.0 | 20.5 | 20.3 | 20.6 | 20.4 | 20.3 |
| Tensile Modulus (psi/Mpa) | 71489/ | 72288/ | 72675/ | 70763/ | 77693/ | 73179/ |
| | 492.9 | 498.4 | 501.1 | 487.9 | 535.7 | 504.6 |
| Weldline Tensile @ Break | 2325/ | 2017/ | 2151/ | 2199/ | 2018/ | 3455/ |
| (psi/MPa) | 16.0 | 13.9 | 14.8 | 15.2 | 13.9 | 23.8 |
| Weldline Elongation (%) | 8.52 | 14.70 | 13.25 | 14.67 | 12.16 | 435.63 |
| Weldline Tensile @ Yield (psi/MPa) | 2566/ | 2650/ | 2663/ | 2708/ | 2579/ | 2593/ |
| | 17.7 | 18.3 | 18.4 | 18.7 | 17.8 | 17.9 |
| Weldline Modulus (psi/MPa) | 72785/ | 65195/ | 66050/ | 70068/ | 70733/ | 67764/ |
| | 501.8 | 449.5 | 455.4 | 483.1 | 487.7 | 467.2 |
| 3-Point Flex Modulus (psi/MPa) | 102314/ | 103787/ | 104750/ | 107198/ | 107550/ | 102662/ |
| | 705.4 | 715.6 | 722.2 | 739.1 | 741.5 | 707.8 |
| 3-Point Flex, 2% Secant Modulus | 93868/ | 94190/ | 95069/ | 94562/ | 95535/ | 93538/ |
| (psi/Mpa) | 647.2 | 649.4 | 655.5 | 652.0 | 658.7 | 644.9 |
| Dynatup (ft-lbs) Total Energy @ | 35.05/ | 37.49/ | 37.64/ | 41.96/ | 40.35/ | 51.05/ |
| 23° C. | 47.5 | 50.8 | 51.0 | 56.9 | 54.7 | 69.2 |
| Dynatup (ft-lbs) Total Energy @ - | 53.93/ | 41.63/ | 45.74/ | 50.68/ | 52.88/ | 48.29/ |
| 30° C. | 73.1 | 56.4 | 62.0 | 68.7 | 71.7 | 65.5 |
| Izod Impact(fpsi/kjsm) @ 23° C. | 13.76/ | 15.51/ | 15.06/ | 15.37/ | 15.27/ | 15.29/ |
| | 28.9 | 32.6 | 31.6 | 32.3 | 32.1 | 32.1 |
| Izod Impact(fpsi/kjsm) @ 0° C. | 5.18/ | 13.85/ | 14.94/ | 14.65/ | 14.67/ | 15.51/ |
| | 10.9 | 29.1 | 31.4 | 30.8 | 30.8 | 32.6 |
| Izod Impact (fpsi/kjsm) @ −20° C. | 0.82/ | 1.99/ | 8.93/ | 8.32/ | 2.89/ | 7.67/ |
| | 1.7 | 4.2 | 18.8 | 17.5 | 6.1 | 16.1 |
| Heat Distortion @ 66 psi in ° C. | 56.0 | 57.7 | 56.1 | 57.4 | 59.8 | 57.3 |
| 12 @ 230° C./2.16 kg load | 7.3 | 2.5 | 1.7 | 1.9 | 2.2 | 2.1 |
| Unnotched Weldline Izod | 10.7/ | 13.3/ | 13.0/ | 13.4/ | 14.1/ | 19.2/ |
| (fpsi/kjsm) | 22.5 | 28.0 | 27.3 | 28.2 | 29.6 | 40.3 |

The data presented in Tables IV, V and VI demonstrate that thermoplastic polymer blends representative of the present invention are readily prepared by adding a crosslinking and branching catalyst at any of a number of points in the process. Illustrative points of addition are prior to extrusion, during extrusion, and after extrusion but prior to or during molding of the polymer blends into an article. The blends may also be prepared in the absence of a catalyst if moisture is readily available and accessible to the elastomer domains for a period of time sufficient to effect a desired level of branching, crosslinking or both. Relative to blends prepared without silane crosslinking to yield a silane crosslinkable phase (Comparative Examples B and C), the blends of the present invention exhibit improved physical properties such as weldline strength, impact strength, tensile strength, tensile elongation at break and shear sensitivity.

### EXAMPLES 26-35

Using a modified version of the procedure for Examples 1-3, a series of ten polymer blends are prepared with a polycarbonate, a polyester or both as the matrix resin. The polycarbonate (PC-2) is a 14 g/10 min MFR (at 300° C., 1.2 kg weight) resin commercially available from The Dow Chemical Company under the trade designation Calibre® 300-15. The polyester is a 0.59 intrinsic viscosity (IV) polyethylene terephthalate (PET) resin commercially available from Shell Chemical Company under the trade designation Traytuf® 5900C. The silane-grafted polymers of Examples 4, 9 and 10 (Table II) are used in preparing the blends. In addition, Examples 32 and 33 contain 40 grams of an ethylene/glycidyl methacrylate (E/GMA) copolymer commercially available from Elf Atochem under the trade designation Lotader® 8840. The E/GMA copolymer is used as a compatibilizer. All examples also contain 4 grams of Irganox® 1076, a phenolic antioxidant (AO-2) commercially available from Ciba Geigy. All Examples further contain an amount of a 25/75 weight based dispersion (CAT) of DBTDL (25 wt %) in mineral oil (75 wt %) at a level as shown in Table VII below. This dispersion is added during or just prior to extrusion of the polymer blend. The extruder operates at a temperature of 275° C. and 250 RPM.

TABLE VII

| Component/ | | | | | | |
|---|---|---|---|---|---|---|
| Example No. | PC-2 | PET | Ex 4 | Ex 9 | Ex 10 | CAT |
| 26 | 1900 | — | 100 | — | — | 0.1 |
| 27 | 1890 | — | — | 110 | — | 0.1 |
| 28 | 1800 | — | — | 200 | — | 0.2 |
| 29 | 1890 | — | — | — | 110 | 0.1 |
| 30 | 1800 | 100 | 100 | — | — | 0.1 |
| 31 | 1790 | 100 | — | 110 | — | 0.1 |
| 32 | 1760 | 100 | 100 | — | — | 0.1 |
| 33 | 1750 | 100 | — | 110 | — | 0.1 |
| 34 | — | 1560 | — | 440 | — | 0.3 |
| 35 | — | 1560 | — | — | 440 | 0.3 |

Molding of Examples 26-35 are accomplished as in Examples 1-3 except that the molding temperatures for the molding machine barrel are all 275° C. and the mold temperature is 170° F. (about 94° C.). The injection cycles are 4 seconds injection, 5 seconds holding and 15 seconds cooling. The molded samples, when subjected to ASTM testing, are expected to behave in a manner similar to Examples 1-3 except where PET is the matrix resin. Tin catalysts tend to at least partially depolymerize polyesters. The depolymerization may be avoided by moisture curing in the absence of a tin catalyst.

TABLE VIII

| Example Number/Test Result | 26 | 27 | 28 | 29 | 30 | 31 |
|---|---|---|---|---|---|---|
| Tensile @ Break (psi/MPa) | 7592/ | 8385/ | 7767/ | 6471/ | 8161/ | 8378/ |
| | 52.4 | 57.8 | 53.6 | 44.6 | 56.3 | 57.8 |
| Elongation (%) | 103 | 122 | 122 | 40 | 119 | 128 |
| Tensile @ Yield (psi/MPa) | 7773/ | 7735/ | 6954/ | 7935/ | 7867/ | 7869/ |
| | 53.6 | 53.3 | 50.0 | 54.7 | 54.3 | 54.3 |
| Tensile Modulus (psi/MPa) | | | | | | |
| Weldline Tensile @ Break | 6474/ | 6559/ | 6395/ | 6552/ | 6824/ | 6576/ |
| (psi/MPa) | 44.6 | 45.2 | 44.1 | 45.2 | 47.1 | 45.4 |
| Weldline Elongation (%) | 10 | 8 | 7 | 10 | 8 | 9 |
| Weldline Tensile @ Yield | 7703/ | 7623/ | 6836/ | 7883/ | 7767/ | 7764/ |
| (psi/MPa) | 53.1 | 52.6 | 47.1 | 54.4 | 53.6 | 53.5 |
| Unnotched Weldline Izod | 22.62/ | 22.68/ | 12.70/ | 22.82/ | 17.92/ | 19.90/ |
| (fpsi/kjsm) | 47.50 | 47.63 | 26.67 | 47.92 | 37.63 | 41.79 |
| 3-Point Flex Modulus (psi/MPa) | 336,454/ | 328,542/ | 295,569/ | 324,867/ | 344,246/ | 360,444/ |
| | 2320.4 | 2265.8 | 2038.4 | 2240.5 | 2374.1 | 2485.8 |
| Dynatup (ft-lbs/J) Total Energy | 45.01/ | 50.16/ | 40.21/ | 37.39/ | 43.17/ | 48.13/ |
| @ 23° C. | 60.8 | 67.7 | 54.3 | 50.5 | 58.3 | 65.0 |
| Dynatup (ft-lbs/J) Total Energy | 51.54/ | 57.72/ | 48.82/ | 40.43/ | 54.14/ | 62.66/ |
| @ −20° C. | 69.6 | 77.9 | 65.9 | 54.6 | 73.1 | 84.6 |
| Dynatup (ft-lbs/J) Total Energy | 42.47/ | 44.23/ | 32.24/ | 33.13/ | 46.32/ | 48.03/ |
| @ −30° C. | 57.3 | 59.7 | 43.5 | 44.7 | 62.5 | 64.8 |
| Izod Impact(fpsi/kjsm) @ 23° C. | 12.87/ | 13.06/ | 11.75/ | 13.00/ | 13.62/ | 13.66/ |
| | 27.0 | 27.4 | 24.7 | 27.3 | 28.6 | 28.7 |
| Izod Impact(fpsi/kjsm) | 11.75/ | 11.97/ | 8.99/ | 6.72/ | 12.24/ | 12.87/ |
| @ −20° C. | 24.7 | 25.1 | 18.9 | 14.1 | 25.7 | 27.0 |
| Izod Impact (fpsi/kjsm) | 10.14/ | 9.84/ | 5.79/ | 3.44/ | 5.49/ | 5.76/ |
| @ −30° C. | 21.3 | 20.7 | 12.2 | 7.2 | 11.5 | 12.1 |
| Heat Distortion @ 66 psi in ° C. | 141.3 | 141.5 | 140.1 | 139.8 | 138.0 | 138.9 |
| MFR @ 300° C./1.2 kg load | 24.46 | 29.96 | | 21.69 | 22.84 | |
| 20 degree GLOSS | 60 | 64 | 26 | 47 | 56 | 56 |
| 60 degree GLOSS | 92 | 94 | 76 | 89 | 92 | 93 |
| 85 degree GLOSS | 95 | 96 | 89 | 94 | 95 | 95 |

TABLE IX

| Example Number/Test Result | 32 | 33 | 34 | 35 |
|---|---|---|---|---|
| Tensile @ Break (psi/MPa) | 7897/ | 8353/ | 4052/ | 4102/ |
| | 54.4 | 57.6 | 27.9 | 28.3 |
| Elongation (%) | 122 | 136 | 8 | 6 |
| Tensile @ Yield (psi/MPa) | 7452/ | 7429/ | 4661/ | 4510/ |
| | 51.4 | 51.2 | 32.1 | 31.1 |
| Tensile Modulus (psi/MPa) | | | | |
| Weldline Tensile @ Break | 5893/ | 6120/ | 3957/ | 4135/ |
| (psi/MPa) | 40.6 | 42.2 | 27.3 | 28.5 |
| Weldline Elongation (%) | 26 | 13 | 9 | 7 |
| Weldline Tensile @ Yield | 7337/ | 7299/ | 4542/ | 4464/ |
| (psi/MPa) | 50.6 | 50.3 | 31.3 | 30.8 |
| Unnotched Weldline Izod | 21.32/ | 21.56/ | 5.58/ | 5.00/ |
| (fpsi/kjsm) | 44.77 | 45.28 | 11.72 | 10.5 |
| 3-Point Flex Modulus (psi/MPa) | 314,497/ | 326,955/ | 240,974/ | 232,650/ |
| | 2168.9 | 2254.8 | 1661.9 | 1604.5 |
| Dynatup (ft-lbs/J) Total Energy | 46.79/ | 49.09/ | 4.46/ | 1.83/ |
| @ 23° C. | 63.2 | 66.3 | 6.0 | 2.5 |
| Dynatup (ft-lbs/J) Total Energy | 46.94/ | 55.54/ | — | — |
| @ −20° C. | 63.4 | 75.0 | | |
| Dynatup (ft-lbs/J) Total Energy | 46.12/ | 45.73/ | — | — |
| @ −30° C. | 62.3 | 61.7 | | |
| Izod Impact(fpsi/kjsm) | 13.88/ | 14.02/ | 0.82/ | 0.78/ |
| @ 23° C. | 29.1 | 29.4 | 1.7 | 1.6 |
| Izod Impact(fpsi/kjsm) | 13.14/ | 13.17/ | — | — |
| @ −20° C. | 27.6 | 27.7 | | |
| Izod Impact (fpsi/kjsm) | 10.41/ | 7.10/ | — | — |
| @ −30° C. | 21.9 | 14.9 | | |
| Heat Distortion @ 66 psi in ° C. | 137.3 | 137.9 | 68.7 | 67.6 |
| MFR @ 300° C./1.2 kg load | 20.05 | 14.06 | 17.89 | 33.62 |
| 20 degree GLOSS | 26 | 16 | 75 | 68 |
| 60 degree GLOSS | 80 | 68 | 90 | 93 |
| 85 degree GLOSS | 95 | 93 | 93 | 91 |

Results similar to those presented in Examples 1-35 are expected with other matrix polymers, elastomer phases, silane materials and catalysts, all of which are disclosed above.

What is claimed is:

1. A thermoplastic polymer blend composition comprising a thermoplastic matrix resin phase that is substantially free of crosslinking and a silane-grafted elastomer phase that is dispersed within the matrix resin phase as individual silane-grafted domains containing an elastomer that is branched, crosslinked or both via silane linkages to an extent sufficient to build elastomer molecular weight and render the domains less susceptible to deformation during processing of the composition than elastomer domains that are substantially free of branching and crosslinking, the thermoplastic matrix resin being at least one resin selected from the group consisting of a poly(alpha-olefin) homopolymer or copolymer, a polycarbonate, a polyester, a polyamide, a polyurethane, an acetal polymer, a styrene polymer or co-polymer, a polyphenylene ether polymer and poly(vinyl chloride), the elastomer phase being at least one polymer selected from the group consisting of substantially linear ethylene polymers, linear ethylene polymers, ultra low density polyethylenes, ethylene/alpha-olefin copolymers, ethylene/vinyl acetate copolymers, diene-modified ethylene/alpha-olefin copolymers and hydrogenated styrene/butadiene block polymers.

2. The composition of claim 1, wherein the elastomer has a density, prior to crosslinking, of less than about 0.920 g/cc.

3. The composition of claim 1, wherein the elastomer has a density, prior to crosslinking, of less than about 0.900 g/cc.

4. The composition of claim 1, wherein the elastomer has a density, prior to crosslinking, of at least about 0.850 g/cc.

5. The composition of claim 1, wherein the hydrogenated styrenic block polymer is at least one diblock or triblock polymer selected from the group consisting of hydrogenated styrene/butadiene polymers, hydrogenated styrene/isoprene polymers, styrene/ethylene/butene/styrene block polymers, and styrene/ ethylene/propylene/ styrene block polymers.

6. The composition of claim 1, wherein the poly(alpha-olefin) matrix resin is at least one of a polypropylene homopolymer and a propylene/alpha-olefin copolymer.

7. The composition of claim 1, further comprising at least one of a thermoplastic elastomer or a core-shell elastomer.

8. The composition of claim 1, wherein silane-grafted elastomer domains, interfacial regions between the silane-grafted elastomer domains and the matrix resin phase or both further comprise a minor amount of at least one additional resin selected from the group consisting of a poly(alpha-olefin), a polycarbonate, a polyester, a polystyrene, and a styrene copolymer.

9. The composition of claim 8, wherein the amount is less than about 20 percent by weight, based upon domain weight.

10. The composition of claim 8, wherein the amount is less than about 15 percent by weight, based upon domain weight.

11. The composition of claim 8, wherein the additional resin is at least partially silane-grafted.

12. The composition of claim 1, further comprising a second elastomer phase that is present as individual domains that are substantially free of silane-grafting, the second elastomer phase comprising at least one elastomer selected from the group consisting of thermoplastic elastomers and core-shell elastomers.

13. The composition of claim 1, wherein components of the composition are present in a weight ratio of matrix resin to silane-grafted elastomer phase that is from about 50 to about 99 parts by weight of matrix resin to from about 50 to about 1 part by weight of elastomer phase, all parts being based on total composition weight, with total weight being 100 parts by weight.

14. The composition of claim 13, wherein the weight ratio is from about 60 to about 97 parts by weight of matrix resin to from about 40 to about 3 parts by weight of elastomer phase.

15. The composition of claim 12, wherein the second elastomer phase is present in an amount of from about 1 to about 30 parts by weight, based on total composition weight.

16. The composition of claim 15, wherein the amount is from about 3 to about 20 parts by weight.

17. The composition of claim 1, further comprising a compatibilizing agent.

18. The composition of claim 17, wherein the compatibilizing agent is a copolymer containing an epoxy functionality, the epoxy functionality being a glycidyl acrylate or aglycidyl methacrylate.

19. A process for preparing a molded article from a thermoplastic polymer blend composition that comprises a thermoplastic matrix resin phase that is substantially free of crosslinking and a silane-grafted elastomer phase that is dispersed within the matrix resin phase as individual silane-grafted domains containing an elastomer that is capable of being branched, crosslinked or both, the process comprising: a) forming a blend of a thermoplastic matrix resin and a silane-grafted elastomer resin; b) converting the blend to a melt blend wherein the elastomer phase is predominantly present as individual domains that are dispersed within the thermoplastic matrix resin phase; and c) converting the melt blend into a shaped article wherein the silane-grafted elastomer phase is branched, lightly crosslinked or both.

20. The process of claim 19 further comprising a step b1) intermediate between steps b) and c) wherein the elastomer phase domains are exposed to an amount of water and for a period of time sufficient to promote branching, crosslinking or both within the domains to an extent sufficient to build elastomer molecular weight within the domains and render the domains less susceptible to deformation during step c) than elastomer domains that are substantially free of crosslinking.

21. The process of claim 19 further comprising a sequential step d) wherein the shaped article is exposed to an amount of water and for a period of time sufficient to promote branching, crosslinking or both within the elastomer phase domains to a level of crosslinking, branching or both that improves impact properties of the shaped article without converting the shaped article to a thermoset article.

22. The process of any of claims 19-21, wherein the thermoplastic blend composition further comprises a second elastomer phase that is present as individual domains that are substantially free of silane-grafting, the second elastomer phase comprising at least one elastomer selected from the group consisting of thermoplastic elastomers and core-shell elastomers, the elastomer(s) for the second phase being added during step a).

23. The process of claim 22, wherein a catalyst that promotes crosslinking, branching or both of the silane-grafted elastomer domains is added to the silane-grafted elastomer resin prior to step a).

24. The process of claim 22, wherein a catalyst that promotes crosslinking, branching or both of the elastomer domains is added to the silane-grafted elastomer resin during step a).

25. The process of claim 22, wherein a catalyst that promotes crosslinking, branching or both of the elastomer domains is added to the melt blend during step b).

26. The process of claim 22, wherein a catalyst that promotes crosslinking, branching or both of the elastomer domains is added to the melt blend after step b) but prior to step c).

27. The process of claim 22, further comprising a step intermediate between steps b) and c) wherein the melt blend is recovered as solid particles.

28. The process of claim 19 or claim 22, further comprising a step intermediate between steps b) and c) wherein the melt blend is recovered as solid particles and wherein a catalyst that promotes crosslinking, branching or both of the elastomer domains is added to the solid particles prior to step c).

29. The process of claim 19 or claim 22, further comprising three sequential steps b1), b2) and b3) that are intermediate between steps b) and c), step b1) comprising recovering the melt blend as solid particles, step b2), which follows step b1), comprising conversion of the solid particles to a melt and step b3), which follows step b2), wherein a catalyst that promotes crosslinking, branching or both of the elastomer domains is added to the melt prior to step c).

30. The process of claim 19 or claim 22, further comprising adding a minor amount of at least one resin selected from the group consisting of a poly(alpha-olefin), a polycarbonate, a polyester, a polystyrene, and a styrene copolymer in step a).

31. The process of claim 19 or claim 22, wherein step c) is a molding process selected from the group consisting of injection molding, blow molding, injection blow molding, extrusion blow molding, co-injection molding, co-extrusion molding, a combination of sheet or film extrusion followed by thermoforming, compression molding and parison molding.

32. The process of claim 30, wherein the molding process is co-injection molding or co-extrusion molding and at least one polymer feedstream for the process contains the thermoplastic polymer blend composition.
